(19) United States
(12) Patent Application Publication
(10) Pub. No.: US 2016/0040812 A1
(43) Pub. Date: Feb. 11, 2016

(54) Quick Connector Structure for a Pipe

(71) Applicant: WEN SHENG FU CO., LTD., Chang Hua Hsien (TW)

(72) Inventor: Hung-Lin Lai, Chang-hua Hsien (TW)

(21) Appl. No.: 14/453,669

(22) Filed: Aug. 7, 2014

(51) Int. Cl. F16L 37/084; F16L 21/08; F16L 55/07; F16L 21/03

(52) U.S. Cl. CPC F16L 37/0842; F16L 21/03; F16L 21/08; F16L 55/07

(57) ABSTRACT

A quick connector structure for a pipe includes a connector body, an O-shaped sealing ring, and a positioning unit. The positioning unit includes an outer shell, a control member, a locking ring and a retaining member.

### BACKGROUND OF THE INVENTION

1. Field of the Invention

The present invention relates to a connector and, more particularly, to a quick connector structure for a pipe.

2. Description of the Related Art

A first conventional quick connector structure for a pipe 76 in accordance with the prior art shown in FIGS. 10 and 11 comprises a connector body 70, a locking nut 71, a detaching ring 72, a locking ring 73, a conical seat 74, and an O-ring 75. The connector body 70 is provided with a first stop portion 701, a first shoulder 702, a second shoulder 703 and a second stop portion 704. The locking nut 71 is mounted in the connector body 70 and is stopped by the first stop portion 701 of the connector body 70. The locking nut 71 prevents the elements in the connector body 70 from being detached from the connector body 70. The pipe 76 is inserted into the connector body 70 and is stopped by the second stop portion 704 of the connector body 70. The detaching ring 72 is mounted in the connector body 70 to release the locked state of the pipe 76. The locking ring 73 is mounted in the connector body 70 and has an annular elastic flange 731 and a plurality of locking teeth 732. The locking teeth 732 are provided on the flange 731 to lock the outer wall of the pipe 76. The conical seat 74 is slidably mounted in the inner wall of the connector body 70 and abuts the locking ring 73. The conical seat 74 is stopped by the first shoulder 702 of the connector body 70. The conical seat 74 and the locking ring 73 are axially movable between the first shoulder 702 and the locking nut 71. The O-ring 75 presses the outer wall of the pipe 76 to provide a sealing effect. The O-ring 75 is stopped by the second shoulder 703 of the connector body 70. In assembly, the locking nut 71, the detaching ring 72, the locking ring 73 and the conical seat 74 are independent and separated, so that the locking nut 71, the detaching ring 72, the locking ring 73 and the conical seat 74 are in turn placed into the connector body 70 during the assembling process. Then, the connector body 70 is worked and bent inward to form the first stop portion 701 to prevent the elements in the connector body 70 from falling out. However, the locking nut 71, the detaching ring 72, the locking ring 73 and the conical seat 74 are easily dropped during the assembling and working process, thereby causing inconvenience and wasting time and energy in assembly of the first conventional quick connector structure.

A second conventional quick connector structure for a pipe 86 in accordance with the prior art shown in FIGS. 12 and 13 comprises a connector body 80, an O-ring 81, a socket 82, a fixing ring 83, a fixing race 84 and a guide sleeve 85. The connector body 80 has an opening 801 provided with a first stepped edge 802 with a smaller diameter and a second stepped edge 803 with a larger diameter. The first stepped edge 802 receives the O-ring 81, and the second stepped edge 803 receives the socket 82, the fixing ring 83 and the fixing race 84. The O-ring 81 has an outer diameter equal to the inner diameter of the first stepped edge 802 of the connector body 80 and has an inner diameter slightly smaller than the outer diameter of the pipe 86. When the pipe 86 is inserted into the opening 801 of the connector body 80, the O-ring 81 provides a sealing effect. The socket 82 has an outer diameter equal to the inner diameter of the second stepped edge 803 of the connector body 80. The socket 82 has an interior provided with an inner stepped edge 821 and has an exterior provided with an outer stepped edge 822. The fixing ring 83 is mounted on the inner stepped edge 821 of the socket 82 and clamped by the fixing race 84. The fixing ring 83 is made of metal and is provided with oblique elastic plates 831 that can be contracted inward and expanded outward. When the elastic plates 831 of the fixing ring 83 are contracted inward, the inner diameter of the elastic plates 831 is smaller than the outer diameter of the pipe 86 to engage the outer wall of the pipe 86, and when the elastic plates 831 of the fixing ring 83 are expanded outward, the inner diameter of the elastic plates 831 is greater than the outer diameter of the pipe 86 to release the outer wall of the pipe 86 so that the pipe 86 can be detached quickly. The fixing race 84 is mounted on the bottom of the socket 82 to fix the fixing ring 83 and has an interior provided with a ramp 841 to evade the elastic plates 831 of the fixing ring 83 when the elastic plates 831 of the fixing ring 83 are expanded outward. The fixing race 84, the fixing ring 83 and the socket 82 are combined to form a combination. In assembly, the opening 801 of the connector body 80 is compressed toward the outer stepped edge 822 of the socket 82 to prevent the combination of the socket 82, the fixing ring 83 and the fixing race 84 from being detached. The guide sleeve 85 has a first side provided with a hooked portion 851 that is forced into the inner stepped edge 821 of the socket 82 and a second side provided with an enlarged ear 852 to facilitate a user pressing the guide sleeve 85. In practice, the socket 82, the fixing ring 83 and the fixing race 84 are combined to form a combination which is then placed into the connector body 80. However, after the combination of the socket 82, the fixing ring 83 and the fixing race 84 is placed into the connector body 80, it still needs to be assembled with the guide sleeve 85. Thus, the guide sleeve 85 is easily dropped during the assembling process.

### BRIEF SUMMARY OF THE INVENTION

In accordance with the present invention, there is provided a quick connector structure for a pipe, comprising a connector body, an O-shaped sealing ring, and a positioning unit. The connector body has an end formed with an opening. The opening of the connector body has an interior provided with a first annular flange and a second annular flange. Each of the first annular flange and the second annular flange of the connector body has a stepped shape. The O-shaped sealing ring is mounted in the opening of the connector body and supported by the first annular flange of the connector body. The positioning unit is mounted on the connector body and supported by the second annular flange of the connector body. The positioning unit includes an outer shell, a control member, a locking ring and a retaining member. The outer shell has an interior formed with a receiving space which axially extends through the outer shell. The receiving space of the outer shell is provided with a first stop and a second stop. Each of the first stop and the second stop of the outer shell has a stepped shape. The outer shell has a first end provided with a reduced portion located adjacent to the first stop and a second end having an inner wall provided with a limit rib. The control member is mounted in the receiving space of the outer shell and has a first end provided with a sleeve protruding outward from the reduced portion of the outer shell and a second end provided with a shoulder abutting the first stop of the outer shell to prevent the control member from being detached from the reduced portion of the outer shell. The shoulder of the control member has an outer oblique guide face. The locking ring is mounted in the receiving space of the outer shell and has an annular base abutting the second stop of the outer shell. The annular base of the locking ring has an inner periphery provided with a plurality of toothed plates directed toward the connector body. The toothed plates of the locking ring extend outward from the annular base and arranged in an inclined manner. The retaining member has an outer periphery provided with a limit groove into which the limit rib of the outer shell is locked, so that the retaining member is fixed on a bottom of the outer shell to prevent the control member and the locking ring from being detached from the outer shell. The retaining member has an inner side provided with a ramp to provide an evading function, so that the toothed plates of the locking ring can be pushed by the shoulder of the control member to expand outward. In assembly, the O-shaped sealing ring and the positioning unit are in turn placed into the opening of the connector body. Then, a clamping portion is formed on the connector body and presses the outer shell of the positioning unit.

According to the primary advantage of the present invention, the outer shell, the control member, the locking ring and the retaining member are initially assembled to construct the positioning unit, and the positioning unit is then placed into the opening of the connector body to prevent the outer shell, the control member, the locking ring and the retaining member from freely falling out of the opening of the connector body during the assembling process, thereby facilitating assembly of the quick connector structure.

According to another advantage of the present invention, the quick connector structure is assembled easily and conveniently, thereby saving the time and energy.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a quick connector structure for a pipe in accordance with the preferred embodiment of the present invention.

FIG. 2 is an exploded perspective view of the quick connector structure for a pipe as shown in FIG. 1.

FIG. 3 is an exploded perspective view of a positioning unit of the quick connector structure for a pipe as shown in FIG. 2.

FIG. 4 is a cross-sectional view of the quick connector structure for a pipe as shown in FIG. 1.

FIG. 5 is a cross-sectional view showing the quick connector structure being connected with a pipe.

FIG. 6 is a cross-sectional view showing the pipe being detached from the quick connector structure.

FIG. 7 is an exploded perspective view of a quick connector structure for a pipe in accordance with another preferred embodiment of the present invention.

FIG. 8 is a cross-sectional assembly view of the quick connector structure for a pipe as shown in FIG. 7.

FIG. 9 is a cross-sectional assembly view in accordance with a further preferred embodiment of the present invention.

FIG. 10 is a cross-sectional view of a first conventional quick connector structure for a pipe in accordance with the prior art.

FIG. 11 is a cross-sectional view showing usage of the first conventional quick connector structure for a pipe as shown in FIG. 10.

FIG. 12 is an exploded perspective view of a second conventional quick connector structure for a pipe in accordance with the prior art.

FIG. 13 is a cross-sectional assembly view of the second conventional quick connector structure for a pipe as shown in FIG. 12.

### DETAILED DESCRIPTION OF THE INVENTION

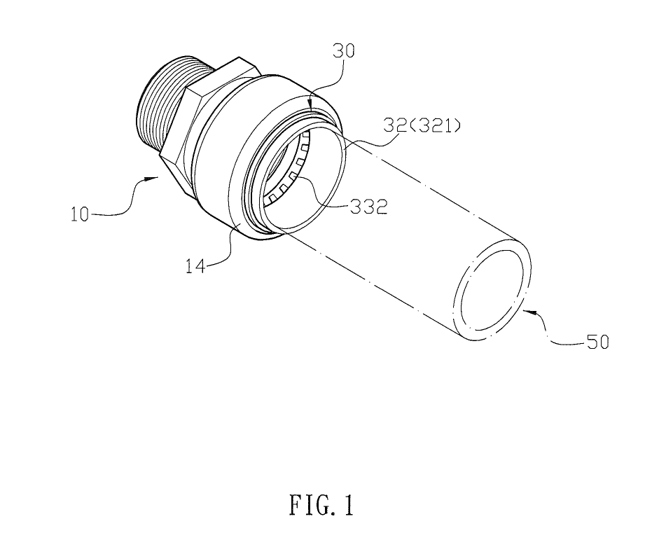

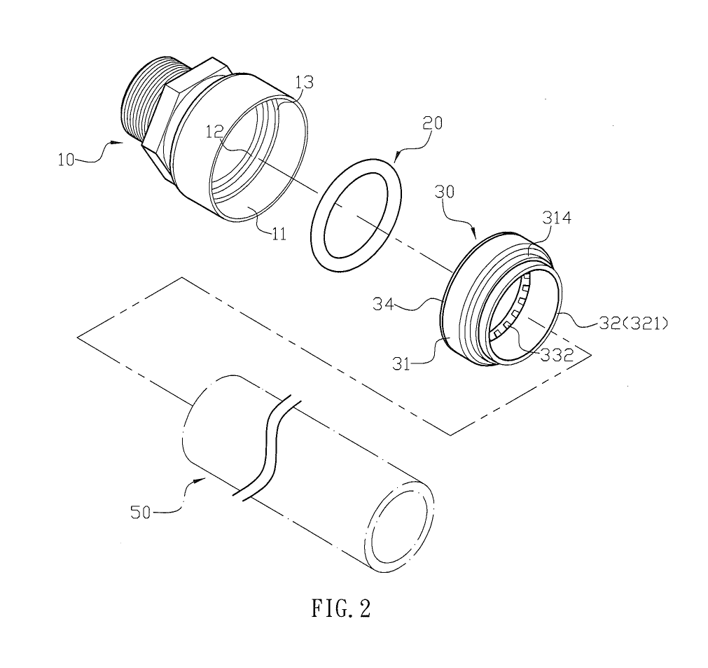

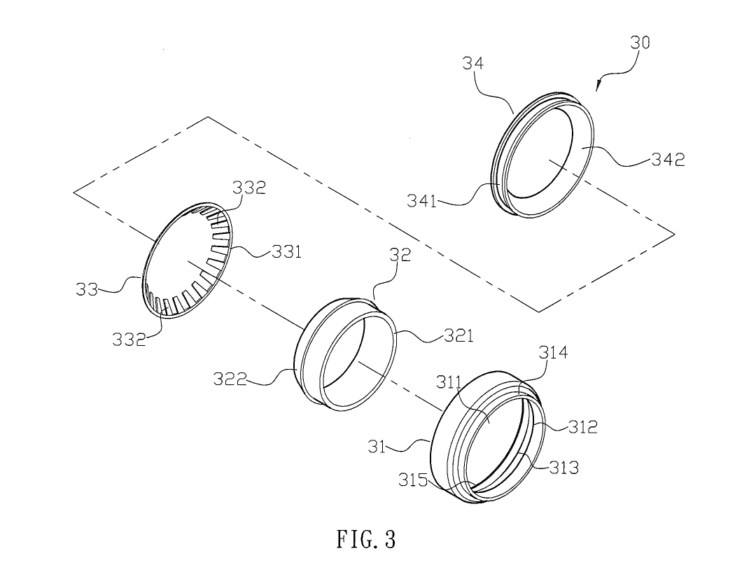

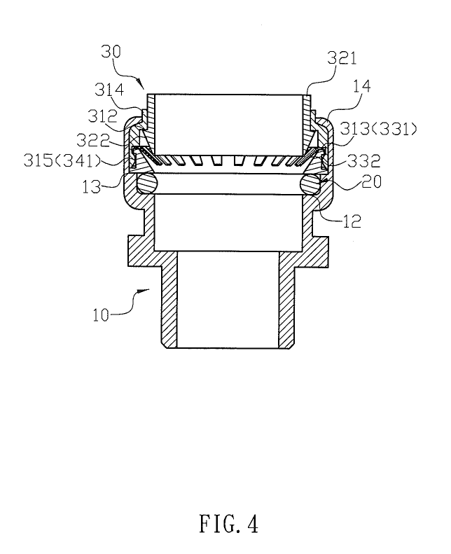

Referring to the drawings and initially to FIGS. 1-4, a quick connector structure for a pipe in accordance with the preferred embodiment of the present invention comprises a connector body 10, an O-shaped sealing ring 20, and a positioning unit 30.

The connector body 10 has an end formed with an opening 11. The opening 11 of the connector body 10 has an interior provided with a first annular flange 12 and a second annular flange 13. Each of the first annular flange 12 and the second annular flange 13 of the connector body 10 has a stepped shape.

The O-shaped sealing ring 20 is mounted in the opening 11 of the connector body 10 and supported by the first annular flange 12 of the connector body 10.

The positioning unit 30 is mounted on the connector body 10 and supported by the second annular flange 13 of the connector body 10. The positioning unit 30 includes an outer shell 31, a control member 32, a locking ring 33 and a retaining member 34.

The outer shell 31 has an interior formed with a receiving space 311 which axially extends through the outer shell 31. The receiving space 311 of the outer shell 31 is provided with a first stop 312 and a second stop 313. Each of the first stop 312 and the second stop 313 of the outer shell 31 has a stepped shape. The outer shell 31 has a first end provided with a reduced portion 314 located adjacent to the first stop 312 and a second end having an inner wall provided with a limit rib 315 located adjacent to the second stop 313.

The control member 32 is mounted in the receiving space 311 of the outer shell 31 and has a first end provided with a sleeve 321 protruding outward from the reduced portion 314 of the outer shell 31 and a second end provided with a shoulder 322 abutting the first stop 312 of the outer shell 31 to prevent the control member 32 from being detached from the reduced portion 314 of the outer shell 31. The shoulder 322 of the control member 32 has an outer oblique guide face.

The locking ring 33 is mounted in the receiving space 311 of the outer shell 31 and has an annular base 331 abutting the second stop 313 of the outer shell 31. The annular base 331 of the locking ring 33 has an inner periphery provided with a plurality of toothed plates 332 directed toward the connector body 10. The toothed plates 332 of the locking ring 33 extend outward from the annular base 331 and arranged in an inclined manner.

The retaining member 34 has an outer periphery provided with a limit groove 341 into which the limit rib 315 of the outer shell 31 is locked, so that the retaining member 34 is fixed on a bottom of the outer shell 31 to prevent the control member 32 and the locking ring 33 from being detached from the outer shell 31. The retaining member 34 has an inner side provided with a ramp 342 to provide an evading function, so that the toothed plates 332 of the locking ring 33 can be pushed by the shoulder 322 of the control member 32 to expand outward.

In assembly, the O-shaped sealing ring 20 is placed into the opening 11 of the connector body 10 and supported by the first annular flange 12 of the connector body 10. Then, the positioning unit 30 is placed into the opening 11 of the connector body 10 and supported by the second annular flange 13 of the connector body 10. Then, the connector body 10 is clamped to form a clamping portion 14 which presses the outer shell 31 of the positioning unit 30.

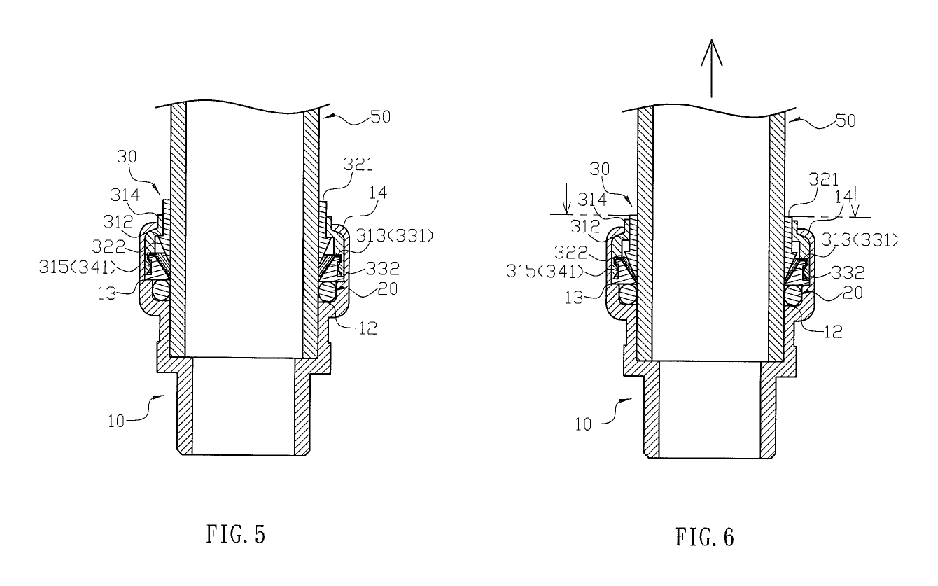

Referring to FIG. 5, a pipe 50 is inserted through the sleeve 321 of the control member 32, the toothed plates 332 of the locking ring 33 and the retaining member 34 into the connector body 10 so that the pipe 50 is combined with the quick connector structure. At this time, the toothed plates 332 of the locking ring 33 engage the outer wall of the pipe 50 to prevent the pipe 50 from being moved back so that the pipe 50 is locked by the toothed plates 332 of the locking ring 33 and is attached to the quick connector structure solidly.

Referring to FIG. 6, when the sleeve 321 of the control member 32 is pressed, the shoulder 322 of the control member 32 is moved toward the toothed plates 332 of the locking ring 33 to push and expand the toothed plates 332 of the locking ring 33 so as to release the pipe 50 from the toothed plates 332 of the locking ring 33 so that the pipe 50 can be detached from the quick connector structure easily and quickly.

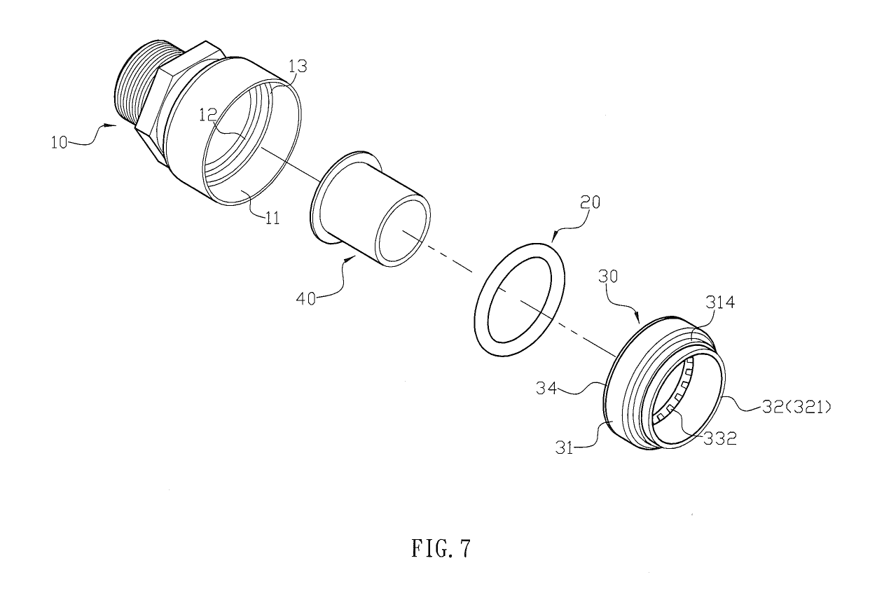

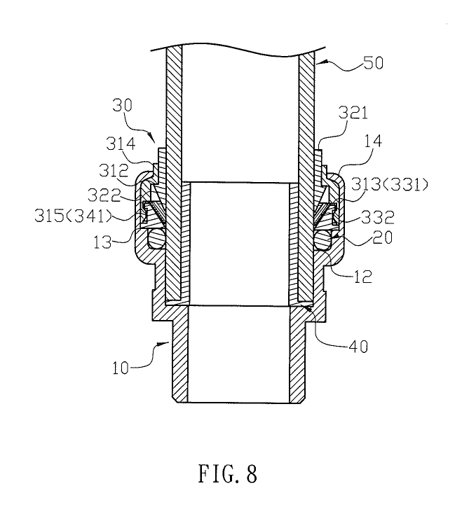

Referring to FIGS. 7 and 8, the quick connector structure for a pipe further comprises an inner sleeve 40 mounted between the connector body 10 and the positioning unit 30. In such a manner, the inner sleeve 40 presses the inner wall of the pipe 50, and the positioning unit 30 presses the outer wall of the pipe 50, so that the pipe 50 is clamped between the inner sleeve 40 and the positioning unit 30. Thus, the pipe 50 is combined with the quick connector structure stably.

As shown in FIGS. 1-8, the quick connector is disposed at a single directional arrangement.

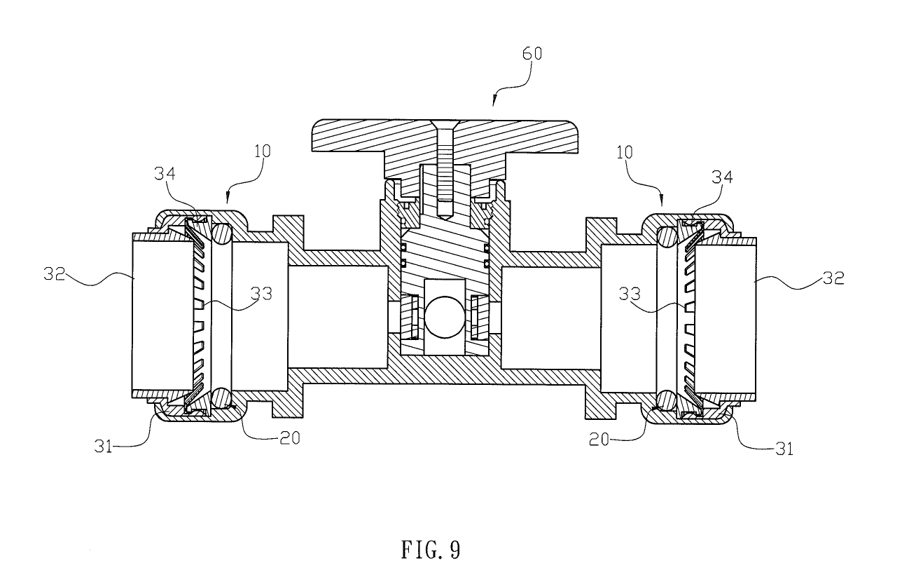

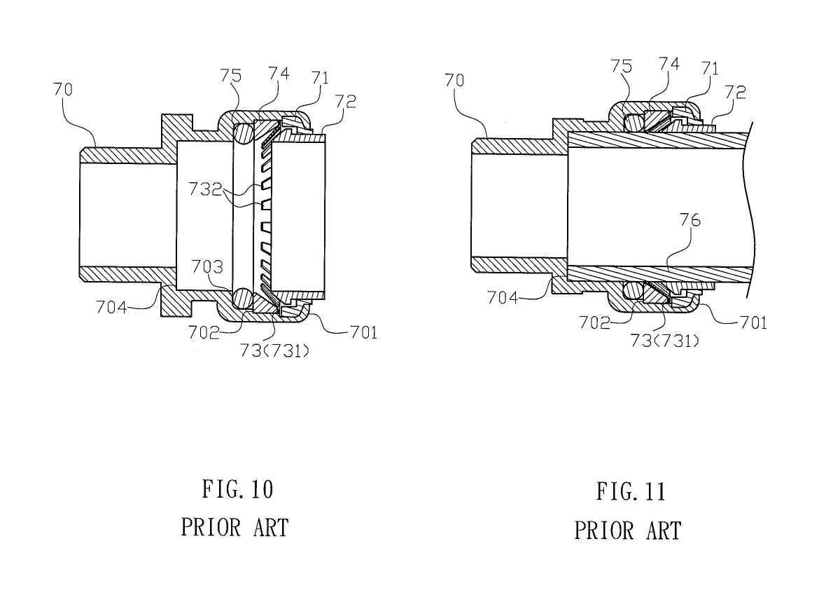

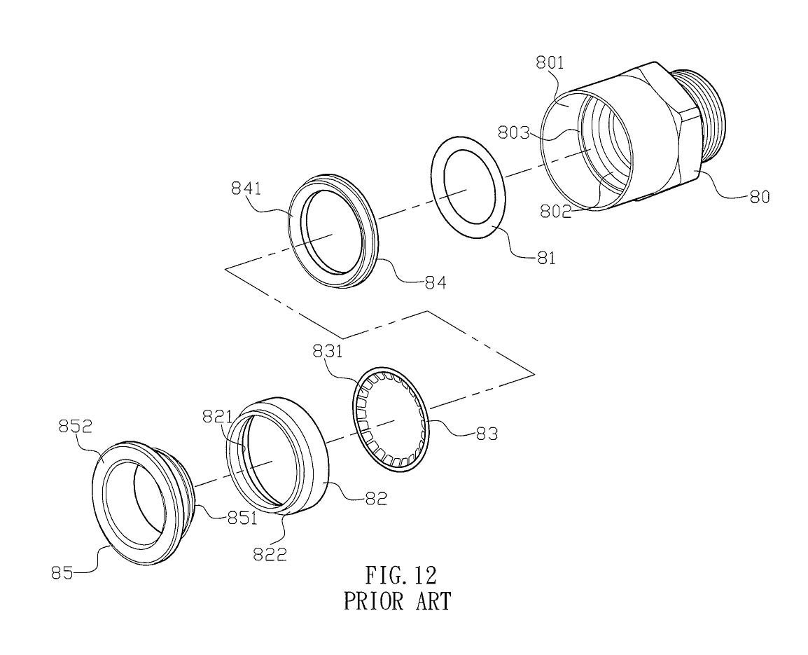

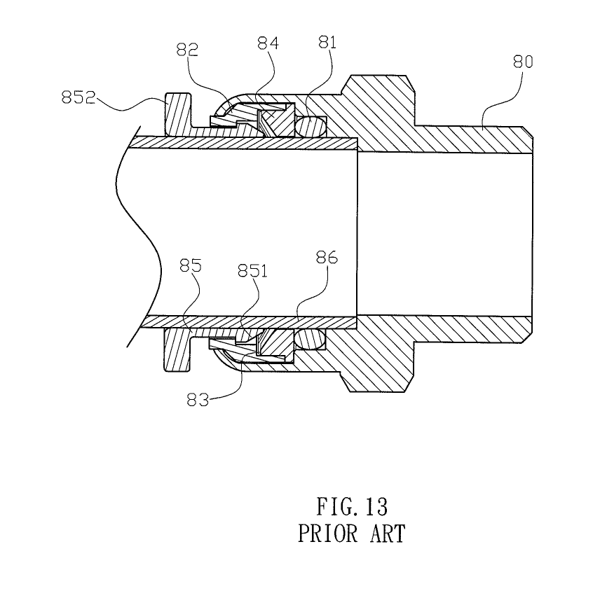

Referring to FIG. 9, the quick connector is disposed at a double directional arrangement. In practice, a water control member 60 is mounted between two quick connectors, and the connector bodies 10 of the two quick connectors are connected, so that the two quick connectors and the water control member 60 construct an open/close valve assembly.

Accordingly, the outer shell 31, the control member 32, the locking ring 33 and the retaining member 34 are initially assembled to construct the positioning unit 30, and the positioning unit 30 is then placed into the opening 11 of the connector body 10 to prevent the outer shell 31, the control member 32, the locking ring 33 and the retaining member 34 from freely falling out of the opening 11 of the connector body 10 during the assembling process, thereby facilitating assembly of the quick connector structure. In addition, the quick connector structure is assembled easily and conveniently, thereby saving the time and energy.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A quick connector structure for a pipe, comprising:
a connector body, an O-shaped sealing ring, and a positioning unit;
wherein:
the connector body has an end formed with an opening;
the opening of the connector body has an interior provided with a first annular flange and a second annular flange;
each of the first annular flange and the second annular flange of the connector body has a stepped shape;
the O-shaped sealing ring is mounted in the opening of the connector body and supported by the first annular flange of the connector body;
the positioning unit is mounted on the connector body and supported by the second annular flange of the connector body;
the positioning unit includes an outer shell, a control member, a locking ring and a retaining member;
the outer shell has an interior formed with a receiving space which axially extends through the outer shell;
the receiving space of the outer shell is provided with a first stop and a second stop;
each of the first stop and the second stop of the outer shell has a stepped shape;
the outer shell has a first end provided with a reduced portion located adjacent to the first stop and a second end having an inner wall provided with a limit rib;
the control member is mounted in the receiving space of the outer shell and has a first end provided with a sleeve protruding outward from the reduced portion of the outer shell and a second end provided with a shoulder abutting the first stop of the outer shell to prevent the control member from being detached from the reduced portion of the outer shell;
the shoulder of the control member has an outer oblique guide face;
the locking ring is mounted in the receiving space of the outer shell and has an annular base abutting the second stop of the outer shell;
the annular base of the locking ring has an inner periphery provided with a plurality of toothed plates directed toward the connector body;
the toothed plates of the locking ring extend outward from the annular base and arranged in an inclined manner;
the retaining member has an outer periphery provided with a limit groove into which the limit rib of the outer shell is locked, so that the retaining member is fixed on a bottom of the outer shell to prevent the control member and the locking ring from being detached from the outer shell;
the retaining member has an inner side provided with a ramp to provide an evading function, so that the toothed plates of the locking ring can be pushed by the shoulder of the control member to expand outward;
the O-shaped sealing ring and the positioning unit are in turn placed into the opening of the connector body; and
a clamping portion is formed on the connector body and presses the outer shell of the positioning unit.

2. The quick connector structure for a pipe of claim 1, further comprising:
an inner sleeve mounted between the connector body and the positioning unit.

3. The quick connector structure for a pipe of claim 1, wherein the quick connector is disposed at a single directional arrangement.

4. The quick connector structure for a pipe of claim 1, wherein:
the quick connector is disposed at a double directional arrangement;
a water control member is mounted between two quick connectors;
the connector bodies of the two quick connectors are connected, so that the two quick connectors and the water control member construct an open/close valve assembly.
